(19) United States
(12) Patent Application Publication
(10) Pub. No.: US 2025/0390921 A1
(43) Pub. Date: Dec. 25, 2025

(54) SYSTEMS AND METHODS FOR GENERATIVE MODEL BASED SEARCH

(71) Applicant: Infobip Ltd., London (GB)

(72) Inventor: Ivan OSMAN, Bistra (HR)

(73) Assignee: Infobip Ltd., London (GB)

(21) Appl. No.: 18/750,471

(22) Filed: Jun. 21, 2024

(51) Int. Cl. G06Q 30/0601; G06F 16/28

(52) U.S. Cl. CPC G06Q 30/0603; G06F 16/287; G06Q 30/0633

(57) ABSTRACT

Systems and methods are disclosed for order management. One or more processors may receive a first data object containing text data related to user interactions. The processors may input the first data object into a machine-learning model configured to identify intents associated with the data. The processors may receive an identified intent from the model and generate a second data object based on the intent, including the intents, a prompt selected based on the intents, and a function selected based on the intents. The processors may input the second data object into another machine-learning model configured to identify item classifications. The processors may receive an item classification data object from the second model and perform actions related to the function based on the item classification data object.

### TECHNICAL FIELD

The present disclosure relates generally to the technical field of data enhancement. More particularly, the present disclosure relates to systems and methods for using machine-learning and/or rule-based techniques for extracting granular information from conversation data.

### BACKGROUND

Traditional methods of managing product orders and interacting with product catalogues often rely on form-based interfaces, which can be cumbersome and time-consuming for users, especially when dealing with extensive product offerings. These traditional approaches often fail to provide an intuitive and user-friendly experience, leading to potential customer frustration and suboptimal engagement with the ordering process. Further, existing conversational interfaces for order management have faced challenges in accurately understanding and processing user intents, particularly when dealing with complex queries or large product catalogues. These systems may struggle to provide relevant and personalized recommendations, hindering the overall user experience and efficiency of the ordering process. The lack of advanced language understanding capabilities in traditional order management systems can lead to misinterpretations of user requests, resulting in incorrect order placements, modifications, or cancellations. This can cause frustration for users and may require additional manual intervention to rectify errors, leading to increased operational costs and reduced customer satisfaction.

The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY

The present disclosure addresses the technical problem(s) described above or elsewhere in the present disclosure and improves the state of data incident response techniques.

In some aspects, the techniques described herein relate to a computer-implemented method including; receiving, by one or more processors, a first data object including text data related to one or more user interactions; inputting, by the one or more processors, the first data object into a first instance of a machine-learning model, the machine-learning model configured to identify one or more intents associated with the first data object; receiving, by the one or more processors, an identified intent from the first instance of the machine-learning model; generating, by the one or more processors based on the identified intent, a second data object, the second data object including the one or more intents, a first prompt selected based on the one or more intents, and a first function selected based on the one or more intents; inputting, by the one or more processors, the second data object into a second instance of the machine-learning model, the second instance of the machine-learning model configured to identify one or more item classifications; receiving, by the one or more processors from the second instance of the machine-learning model, an item classification data object; and performing, by the one or more processors based on the item classification data object, one or more actions related to the first function.

In some aspects, the techniques described herein relate to a system including memory and one or more processors communicatively coupled to the memory, the one or more processors configured to: receive a first data object including text data related to one or more user interactions; input the first data object into a first instance of a machine-learning model, the machine-learning model configured to identify one or more intents associated with the first data object; receive an identified intent from the first instance of the machine-learning model; generate, based on the identified intent, a second data object, the second data object including the one or more intents, a first prompt selected based on the one or more intents, and a first function selected based on the one or more intents; input the second data object into a second instance of the machine-learning model, the second instance of the machine-learning model configured to identify one or more item classifications; receive, from the second instance of the machine-learning model, an item classification data object; and perform, based on the item classification data object, one or more actions related to the first function.

In some aspects, the techniques described herein relate to one or more non-transitory computer-readable storage media including instructions that, when executed by one or more processors, cause the one or more processors to: receive a first data object including text data related to one or more user interactions; input the first data object into a first instance of a machine-learning model, the machine-learning model configured to identify one or more intents associated with the first data object; receive an identified intent from the first instance of the machine-learning model; generate, based on the identified intent, a second data object, the second data object including the one or more intents, a first prompt selected based on the one or more intents, and a first function selected based on the one or more intents; input the second data object into a second instance of the machine-learning model, the second instance of the machine-learning model configured to identify one or more item classifications; receive, from the second instance of the machine-learning model, an item classification data object; and perform, based on the item classification data object, one or more actions related to the first function.

It is to be understood that both the foregoing general description and the following detailed description are example and explanatory only and are not restrictive of the detailed embodiments, as claimed.

### BRIEF DESCRIPTION OF THE DRAWINGS

The accompanying drawings, which are incorporated in and constitute a part of this specification, illustrate various example embodiments and together with the description, serve to explain the principles of the disclosed embodiments.

FIG. 1A is a diagram showing an example of a system environment, according to some embodiments of the disclosure.

FIG. 1B is a diagram of example components of a signal extraction platform, according to some embodiments of the disclosure.

FIG. 1C is a diagram of example components of a data enhancement module, according to some embodiments of the disclosure.

FIG. 2 is a flowchart showing a method for data extraction, according to some embodiments of the disclosure.

FIG. 3 is a flowchart of one or more functions, according to some embodiments of the disclosure.

FIG. 4 is a block diagram illustrating an example system environment for an order management system, according to some embodiments of the disclosure.

FIG. 5 is a flowchart illustrating the data flow within an order management system utilizing, according to some embodiments of the disclosure.

FIG. 6 is s a block diagram depicting the interactions and data flow within an order management system, according to some embodiments of the disclosure.

FIG. 7 shows an example machine-learning training flow chart, according to some embodiments of the disclosure.

FIG. 8 illustrates an implementation of a computer system that executes techniques presented herein, according to some embodiments of the disclosure.

### DETAILED DESCRIPTION

The present disclosure pertains to the technical field of data extraction. This disclosure encompasses techniques for extracting data based on user interactions. Specifically, it introduces systems and methods to extract data signals from interaction data by leveraging machine-learning and rules-based approaches.

Traditional approaches to conversational order management often rely on rigid, rule-based systems or simple keyword matching to interpret user intents and process orders. These methods struggle to accurately understand and respond to the wide range of natural language expressions that customers may use, leading to misinterpretations, incorrect order processing, and frustrating user experiences. As a result, customers may abandon their orders or require additional human intervention to resolve issues, increasing operational costs and reducing customer satisfaction.

Furthermore, traditional systems often operate using predefined product catalogs and static order management workflows. This inflexibility makes it difficult to adapt to changing product offerings, promotions, or customer preferences without significant manual effort and system updates. In an era of rapidly evolving market dynamics and customer expectations, the inability to quickly incorporate new products, adjust pricing, or modify order processing logic can put businesses at a competitive disadvantage.

Another significant drawback of traditional approaches is their limited ability to leverage historical data and learn from past interactions to improve future performance. These systems often rely on manually defined rules and heuristics, which can be time-consuming to create and maintain, and may not capture the full complexity and nuances of customer behavior. Without the ability to automatically learn and adapt based on data, traditional systems may struggle to provide personalized recommendations, optimize order processing, or identify patterns and trends that could inform business strategies.

To address concerns such as the above, the present disclosure provides systems and methods natural language processing techniques, powered by large language models and machine-learning, to accurately understand and interpret customer intents from conversational interactions. By training on vast amounts of diverse language data, the system can effectively handle the variability and ambiguity inherent in human communication. This enables more accurate intent recognition, entity extraction, and context understanding, allowing the system to provide relevant and personalized responses, streamline order processing, and minimize errors and misinterpretations.

Moreover, the proposed system employs a modular and flexible architecture that allows for seamless integration with existing product catalogs, inventory management systems, and order processing workflows. By decoupling the conversational interface from the underlying logic, the system can easily adapt to changes in product offerings, pricing, promotions, or business rules without requiring extensive manual intervention or system downtime. This agility enables entities to quickly respond to market dynamics, customer preferences, and operational requirements, providing a technical flexibility.

Another technical advantage of the proposed system is its ability to continuously learn and improve over time through machine-learning and data-driven optimization. By capturing and analyzing data from each interaction, the system can automatically refine its language understanding models, improve intent classification accuracy, and optimize dialogue management strategies. Furthermore, the system can leverage this data to generate valuable insights into customer preferences, purchasing patterns, and trends, enabling entities to make informed decisions, personalize offerings, and proactively address customer needs. This self-learning capability allows the system to constantly evolve and adapt to changing customer behaviors and market conditions, ensuring sustained performance and value over time.

The technical improvements and advantages discussed above are not the sole improvements and advantages, and additional technical improvements and advantages will be discussed in the following sections. Further, based on the present disclosure, other technical improvements and advantages will be apparent to one of ordinary skill in the art.

As an illustrative example, consider a practical application wherein a customer engages with an e-commerce platform through a conversational interface to manage their product orders. This scenario unfolds as follows: the customer initiates a conversation with the system, expressing their intent to add a specific item to their shopping cart. This interaction generates a data object that encapsulates the text data related to the customer's request. The system, equipped with one or more processors, receives this interaction data object and inputs it to a first instance of a machine-learning model, which is trained to identify the user's intent (in this case, adding an item to the cart).

Following the intent identification, the system generates a second data object based on the identified intent. This second data object includes the identified intent, a prompt selected based on the intent (e.g., a prompt to specify the desired quantity of the item), and a function selected based on the intent (e.g., an “add to cart” function). The system then inputs the second data object to a second instance of the machine-learning model, which is specifically trained to identify item classifications based on the user's input.

Upon processing the second data object through the second instance of the machine-learning model, an item classification data object is produced, containing indicators that help identify the specific item the customer wishes to add to their cart. Utilizing this item classification data object, the system performs the selected “add to cart” function, modifying the customer's shopping cart data to include the specified item and quantity. This updated shopping cart data is then presented to the customer for confirmation and further interaction.

This example underscores the efficiency of the disclosed system in streamlining the order management process, enhancing customer experience, and enabling more accurate and timely processing of user requests. By directly extracting and analyzing signals from real-time user interactions, the system proactively identifies the user's intent and the specific items they are interested in, allowing for swift and appropriate actions to be taken. This approach not only exemplifies the system's capability to navigate through complex product catalogues with precision but also highlights its potential to significantly impact customer satisfaction and engagement through intuitive and personalized conversational interactions.

While principles of the present disclosure are described herein with reference to illustrative embodiments for particular applications, it should be understood that the disclosure is not limited thereto. Those having ordinary skill in the art and access to the teachings provided herein will recognize additional modifications, applications, embodiments, and substitution of equivalents all fall within the scope of the embodiments described herein. Accordingly, the disclosure is not to be considered as limited by the foregoing description.

Various non-limiting embodiments of the present disclosure will now be described to provide an overall understanding of the principles of the structure, function, and use of systems and methods disclosed herein for data extraction.

Reference to any particular activity is provided in this disclosure only for convenience and not intended to limit the disclosure. A person of ordinary skill in the art would recognize that the concepts underlying the disclosed devices and methods may be utilized in any suitable activity. For example, while the present disclosure is in the context of order management, one of ordinary skill would understand the applicability of the described systems and methods to similar tasks in a variety of contexts or environments. The disclosure may be understood with reference to the following description and the appended drawings, wherein like elements are referred to with the same reference numerals.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially” and “generally,” are used to indicate a possible variation of +10% of a stated or understood value.

It will also be understood that, although the terms first, second, third, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

As used herein, a “machine-learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine-learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine-learning model may operate on an input linearly, in parallel, via a network (e.g., a neural network), or via any suitable configuration.

As used herein, an “order basket” or “shopping cart” refers to a virtual container or data structure within an online or electronic commerce system that holds a collection of items or services selected by a user for potential purchase. This digital construct allows users to browse, select, and manage products or services they intend to buy, mimicking the functionality of a physical shopping cart in a traditional retail setting. The order basket or shopping cart maintains a record of the selected items, quantities, prices, and other relevant details, enabling users to review, modify, or remove items before proceeding to the checkout process. This feature serves as a component of online shopping, providing a convenient and organized way for users to keep track of their intended purchases while continuing to explore other offerings on the e-commerce platform.

Training the machine-learning model may include one or more machine-learning techniques, such as linear regression, logistical regression, random forest, gradient boosted machine (GBM), deep learning, and/or a deep neural network. Supervised and/or unsupervised training may be employed. For example, supervised learning may include providing training data and labels corresponding to the training data, e.g., as ground truth. Unsupervised approaches may include clustering, classification or the like. K-Prototypes or K-Means may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc. After training the machine-learning mode, the machine-learning model may be deployed in a computer application for use on new input data that it has not been trained on previously.

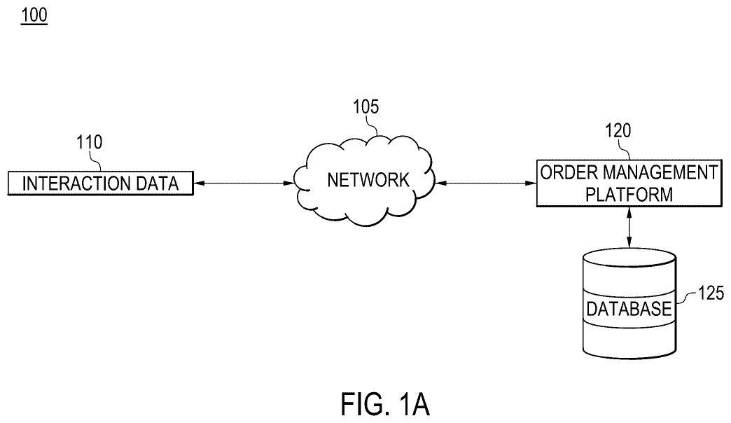

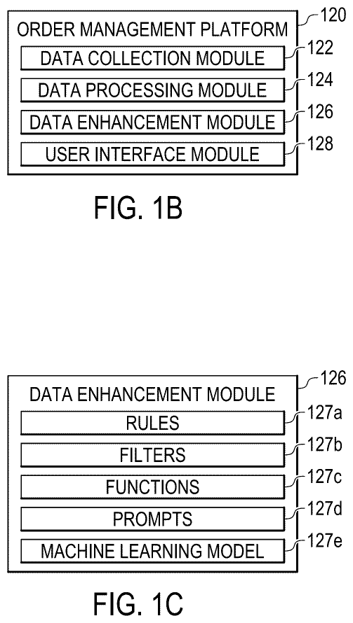

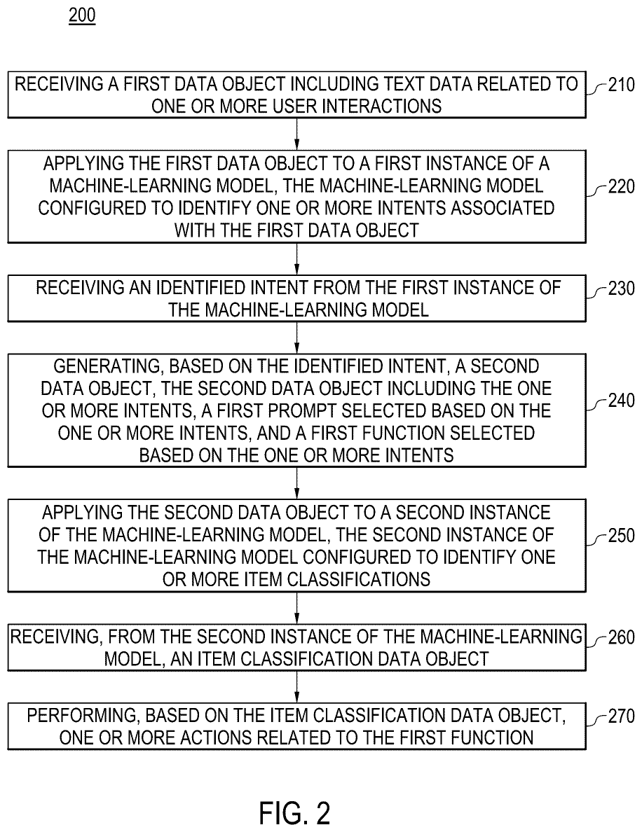

FIG. 1A illustrates a diagram of a system configured for the management of orders through conversational interactions, in accordance with certain embodiments of the present disclosure. The depicted environment, labeled as environment 100, is consistent with a specific embodiment of this disclosure. Environment 100 encompasses a communication infrastructure termed as network 105, which facilitates connectivity to various user interaction data 110 sources, and further integrates with an order management platform 120 that incorporates a database 125. This database 125 is structured to store and manage interaction data objects alongside generated data objects, embodying a rich dataset where the data objects represent various aspects of interactions such as user intents, item classifications, and performed actions. The database 125 may also include one or more catalogues and one or more shopping carts, each containing item information related to one or more items.

In some embodiments, various components within environment 100 interact via network 105. Network 105 facilitates communication between the order management platform 120 and other systems, including one or more systems such as user interaction data 110. User interaction data 110 may contain data, data entries, and/or data objects relevant to interaction-related activities within the conversational order management environment. Network 105 may encompass various types of networks, including, but not limited to, data networks, wireless networks, telephony networks, or any combination thereof, to support robust and secure data exchange across environment 100. Within environment 100, any of these components, including user interaction data 110 sources, order management platform 120, and one or more additional systems, may communicate with one another based on established access permissions.

Any of the user interaction data 110 sources, the database 125, and/or one or more other systems associated with the order management platform 120 may contain a diverse collection of structured and/or unstructured data pertinent to user interactions, intents, item classifications, and performed actions. In some embodiments, this data, organized into one or more data objects, spans a variety of dimensions including transcripts of user interactions, intent classifications, item classifications, performed actions, API request and response data related to interaction data exchanges, security and compliance documentation, along with insights from interaction data analytics. This extensive repository, which includes interaction records, intent and item classification data, action data, and the like, may be stored in storage solutions that range from local to cloud-based data storage systems, ensuring secure storage and accessibility for ongoing processing and interaction data analytical evaluation.

The database 125 may support the storage and retrieval of data related to one or more datasets and/or data objects, such as interaction data from chat conversations, voice transcripts, or text messages, as well as product catalogs, user profiles, order histories, intent data objects, item classification data objects, action data objects, and API request and response data related to interaction and order data exchanges. It stores metadata and operational data about entities represented in these datasets, as well as information received from the order management platform 120. Database 125 may comprise systems like a relational database management system (RDBMS), NoSQL database, or graph database, tailored to the specific needs and use cases within environment 100, particularly for managing the complex, interconnected data at the intersection of e-commerce and user interactions.

In some embodiments, database 125 may embody any type of database system where data is systematically arranged in structures such as tables, graphs, or other suitable formats. It is configured to store and facilitate retrieval of data utilized by the order management platform 120, encompassing interaction data, product information, user preferences, order histories, data relationships, and platform-generated outcomes. Furthermore, database 125 maintains a vast array of information to aid in the analysis, prediction, and management of order-related outcomes based on insights derived from user interactions within environment 100.

In some embodiments, database 125 comprises a machine-learning-based analytics database outlining relationships, associations, and connections between input parameters from interaction data and product catalogs, and output parameters representing interaction-related metrics for intent classification, item classification, action performance, and order outcome prediction. This leverages machine-learning algorithms to learn mappings between data inputs (e.g., interaction text, user attributes, order history) and outputs such as intent prediction accuracy, item classification effectiveness, action performance precision, and correlations between interaction signals and order outcomes. This analytics database is periodically updated to incorporate additional insights from ongoing machine-learning processes.

Signal extraction platform 120 interacts with other components within network 105 using established or evolving communication protocols. These protocols ensure efficient interactions between nodes and dictate conventions for creating, sending, and interpreting data exchanges across communication links. They operate across different layers, from generating physical signals to facilitating specific software applications engaged in transmitting or receiving interaction data 110, enabling robust and secure data flow within environment 100 for comprehensive analysis at the intersection of user interactions and order management outcomes.

Communications between the various components of the networks are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers.

In operation, environment 100 serves as a platform for processing and analyzing interaction data, utilizing techniques such as data analytics, artificial intelligence, and database management. For instance, in an embodiment, environment 100 facilitates the generation of insights, metrics, and data objects from various datasets, including user interaction data and catalogue records, according to predefined criteria or multiple parameters.

To fulfill these functions, the order management platform 120 may utilize one or more methodologies, such as the deployment of machine-learning models within the data enhancement module 126, specifically configured to analyze interaction data and product information to uncover patterns, trends, and/or anomalies across environment 100. Moreover, the order management platform 120 leverages the data collection module 122 and the data processing module 124 to aggregate and refine interaction-related data, including user intents, item classifications, and performed actions for advanced analysis.

For optimized data storage and retrieval, the database 125 is capable of archiving metadata associated with interaction data and product catalogs, encompassing information on data sources, types, and structures. This database 125 further maintains records on the insights generated by the order management platform 120, such as intent-item-action relationships, order outcomes, and statistical data on user interactions and their correlation with order-related factors.

Beyond the analysis of interaction data and product information, environment 100 facilitates a variety of applications, from data visualization and search functionalities to predictive modeling. For instance, environment 100 enables e-commerce businesses or users to query interaction data for specific indicators that match given criteria, such as particular user intents or product-related signals, or to visualize interaction statistics and their correlation with order outcomes through dynamic graphs and charts.

In this manner, environment 100 not only supports the comprehensive analysis of user interactions in the context of e-commerce but also enables data-driven decision-making and intervention strategies. By leveraging advanced analytics and machine-learning techniques on the rich dataset formed by the intersection of interaction data and product information, the system can uncover one or more insights into user behaviors, preferences, and order-related needs. These insights can then be translated into targeted actions, such as personalized product recommendations, proactive customer support, or inventory management optimization, leading to improved order management outcomes and enhanced user experiences within the e-commerce ecosystem.

FIG. 1B is a diagram illustrating example components of the order management platform 120, in accordance with some embodiments. In some embodiments, order management platform 120, as part of environment 100, is configured to analyze diverse datasets, such as interaction data and product catalogs, and generate data objects, including insights and metrics pertinent to user intents, item classifications, and performed actions. The terms “component” or “module” within this depiction are inclusive of both hardware and software elements implemented via a processor or comparable technology. Notably, the order management platform 120 comprises modules dedicated to the collection, processing, and enhancement of interaction data, as well as the generation of informative data objects. These encompass the data collection module 122, the data processing module 124, the data enhancement module 126, and the user interface module 129. The architecture provides versatility in the configuration of these modules, allowing for the integration of their functions into a consolidated framework or the distribution across various modules with akin functionalities.

In some embodiments, the data collection module 122 of the order management platform 120 is tasked with the acquisition of interaction data from one or more sources and in one or more formats during the functioning of one or more systems of environment 100. This module is configured to manage various data types, including, but not limited to, chat conversations, voice transcripts, text messages, user feedback, other user interactions with one or more systems of environment 100, associated metadata, and the like. It is also configured to handle proprietary or generated data such as interaction analytics, generated prompts and/or outputs, training data, user profiles, and outcomes from predictive modeling based on interaction data.

The interaction data is ingested into the system via multiple pathways, providing flexibility in the collection mechanism for the order management platform 120. One such pathway involves an Application Programming Interface (API) that establishes a secure communication channel for automated data transfer between the data collection module 122 and user interaction data 110 sources, enabling real-time and/or batch-based data acquisition. An alternative pathway permits manual input by authorized personnel through a dedicated user interface module 129, where input methods include file uploads or direct data entry into predefined fields. Furthermore, data intake can be facilitated through third-party integrations, middleware, or direct database queries aimed at populating database 125. The data collection module 122 also implements data validation and integrity checks to ensure the accuracy and reliability of the ingested interaction data.

In some embodiments, the interaction data may be ingested into the order management platform 120 via one or more input portals. These input portals serve as the primary interface between users and the system, facilitating the collection of interaction data in various formats. The input portals can be integrated into a wide range of messaging platforms and communication channels, such as text messaging (SMS), email, mobile applications, websites, or dedicated conversational interfaces. One such input portal can take the form of an interactive chatbot, which provides a conversational interface for users to engage with the order management platform 120 across multiple platforms. The chatbot leverages natural language processing (NLP) and machine-learning techniques to understand and respond to user queries, requests, and commands related to order management, regardless of the specific communication channel used. Through this interactive chatbot, users can input their intentions, preferences, and order-related information in a natural, conversational manner, whether via text messaging, email, in-app interactions, or web-based interfaces. The chatbot can then process this interaction data, extracting relevant information such as user intents, item references, quantities, and other order-specific details. This extracted data is then passed on to the data collection module 122 for further processing and integration into the order management workflow. By supporting multiple messaging platforms and communication channels, the order management platform 120 ensures that users can interact with the system using their preferred method of communication, enhancing accessibility and user experience.

In some embodiments, the data processing module 124 of the order management platform 120 is configured to process and prepare the collected interaction data for further analysis by the data enhancement module 126. The data processing module 124 is configured to augment and/or cleanse the data, removing irrelevant or redundant information, and/or converting the data into a format that is amenable for analysis by the data enhancement module 126. This module is configured to refine the initial data collection, transforming raw, heterogeneous interaction data into a standardized, uniform format for downstream analysis. The data processing module 124 utilizes a variety of algorithms for data standardization, thereby addressing discrepancies in data types, formats, or terminologies emanating from diverse sources.

Additionally, the data processing module 124 incorporates error-handling mechanisms configured to identify and amend potential inaccuracies or anomalies within the interaction data. These mechanisms may include rule-based checks, probabilistic data matching, or data imputation techniques, which are all targeted at preserving the quality and integrity of the data. The data processing module 124 also supports parallel processing capabilities, allowing for the concurrent handling of multiple data streams. This feature is particularly advantageous for processing large volumes of interaction data or enabling real-time analytics.

Upon receiving the processed interaction data from the data processing module 124, the data enhancement module 126 is configured to utilize this data within a structured framework configured to facilitate advanced intent classification, subject determination, and signal extraction. This module leverages the capabilities of one or more rules 127a and/or one or more machine-learning models to interpret and analyze the complex relationships in interaction data, including but not limited to user intents, interaction subjects, and extracted signals. The data enhancement module 126 systematically processes the interaction data through these models, enabling the dynamic identification of various interaction-related entities and their interconnections.

In some embodiments, the data enhancement module 126 utilizes an attention-based deep learning architecture to assign variable importance to different aspects of the interaction data, allowing for an understanding of the relationships between user intents, interaction subjects, and extracted signals. Furthermore, the data enhancement module 126 is equipped with machine-learning algorithms capable of inferring missing or incomplete information within the interaction data, employing techniques such as data imputation or transfer learning. The data enhancement module 126 is configured to integrate and analyze heterogeneous interaction data sources, from email conversations to call transcripts, by creating a comprehensive, interconnected representation of the data. This integrative approach enables the exploration of potential new correlations and insights into user behaviors, preferences, and needs that may not be evident from isolated data points, and enables predictions of intents and subjects based on the processed interaction data. In some embodiments, the data enhancement module 126 is configured to execute one or more queries and/or one or more modifications against the processed interaction data, facilitating the identification of user intents, determination of interaction subjects, and extraction of relevant signals.

FIG. 1C is a diagram illustrating example components of the data enhancement module 126, in accordance with some embodiments. The data enhancement module 126 is configured to enrich and/or otherwise modify the interaction data with additional insights, context, and functionality. It comprises several sub-components, including rules 127a, filters 127b, functions 127c, prompts 127d, and machine-learning model 127e. These sub-components work together to process the interaction data, extract relevant information, and generate enhanced data objects that facilitate more accurate and efficient order management.

In some embodiments, rules 127a within the data enhancement module 126 define a set of predefined guidelines, conditions, and constraints that are applied to the interaction data. These rules can be based on business logic, domain knowledge, regulatory requirements, or one or more additional objectives specific to the order management process. For example, rules 127a may include validation checks to ensure that required fields such as item name, quantity, and the like are present in the interaction data. They may also enforce certain constraints, such as minimum or maximum order quantities, or restrict certain items from being purchased based on user roles or permissions.

In some embodiments, filters 127b are used to refine and narrow down the interaction data based on specific criteria. These filters can be applied to various aspects of the interaction data, such as user intents, item classifications, or order attributes. For instance, filters 127b may be used to isolate interactions related to a specific product category, a particular time period, a certain user segment, a certain item catalogue or classification, or the like. By applying these filters, the data enhancement module 126 can focus on a subset of the interaction data that is most relevant to the current order management context, improving the efficiency and accuracy of subsequent processing steps. Filters 127b may be dynamically generated based on one or more system or data state, or may be pre-defined.

In some embodiments, functions 127c represent a set of predefined system operations that can be triggered based on the interaction data. These functions are related to specific actions or tasks within the order management process, such as “catalogue search”, “add item”, “remove item”, or “modify quantity”. For example, if a user expresses an intent to add a specific item to their order, the corresponding “add item” function would be invoked to process that request. Similarly, if a user wants to remove an item from their order, the “remove item” function would be triggered. These functions encapsulate the necessary logic and procedures to execute the desired action, interacting with the underlying databases and system components to update the order state accordingly.

In some embodiments, prompts 127d are predefined or dynamically generated prompts that are added to the data object before it is passed to the language models for processing. These prompts are configured to provide additional context, guidance, or instructions to the language models, helping them generate more accurate and relevant responses. The prompts can be tailored to specific use cases, user intents, or system requirements. For example, a prompt may be added to the data object to instruct the language model to focus on generating a response that confirms the user's order details and provides an order summary. Another prompt may guide the language model to ask clarifying questions if the user's intent is ambiguous or if required information is missing. These prompts can be predefined for common scenarios or dynamically generated based on the current state of the interaction and the data objects involved.

In some embodiments, machine-learning model 127e is configured be applied to various aspects of the system, such as intent classification, item recommendation, or order management functions. By leveraging historical interaction data, order outcomes, and user feedback, the machine-learning model 127e can learn patterns, preferences, and relationships that can be used to improve the accuracy and efficiency of the order management process.

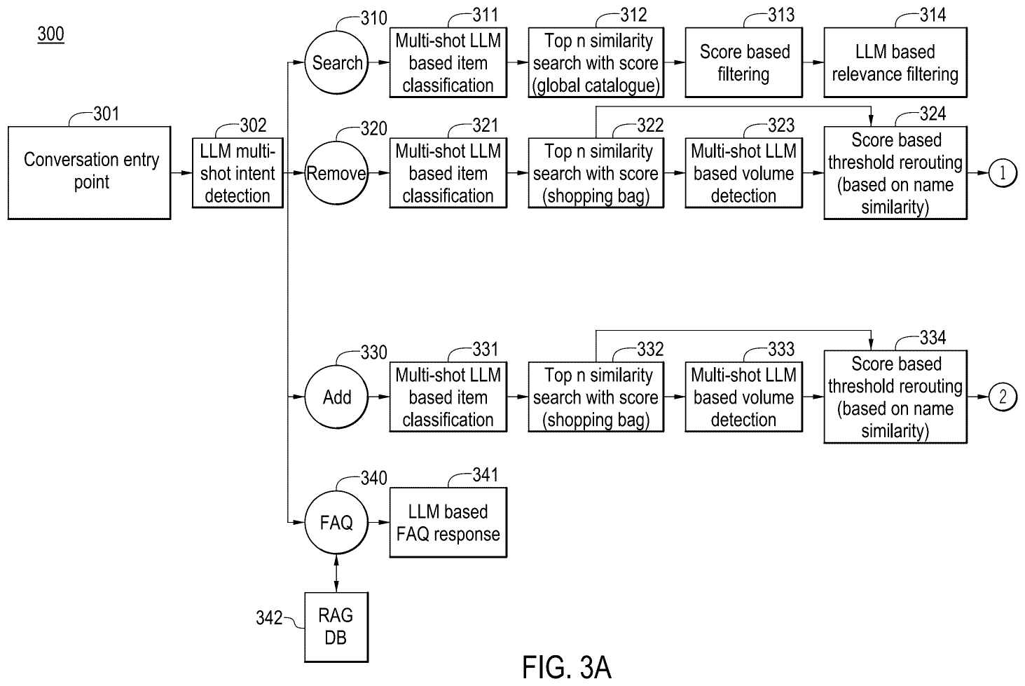

FIG. 2 is a flowchart showing a computer-implemented method 200 for order management according to some embodiments of the disclosure. In some embodiments, method 200 includes step 210 of receiving, by one or more processors, a first data object including text data related to one or more user interactions. The first data object is configured to encapsulate various types of information pertaining to the user interactions, such as user input, queries, requests, or commands related to order management. The first data object may be generated by transforming user interactions from one or more first formats (e.g., related to user input, queries, requests, or commands) into a harmonized second format (e.g., variables, values, indicators, pointers, etc.) such that the second format may be uniform or may uniformly covney the different types of user interactions. This text data may be obtained from one or more of a wide range of sources, including but not limited to, chat conversations, voice transcripts, text messages, email messages, or any other form of textual communication between the user and the order management system. For example, text data may be generated based on audio or voice data or may be generated based on transcribing audio or video data. The first data object is further configured to include metadata associated with the user interactions, such as timestamps, user identifiers, session identifiers, or device information. The reception of the first data object by the one or more processors may be facilitated through various input portals or interfaces, such as chatbots, messaging platforms, mobile applications, web forms, or voice assistants, which are configured to capture and transmit the user interaction data to the order management system. Upon receiving the first data object, the one or more processors are configured to store the text data and associated metadata in a database 125 or any other suitable storage medium for further processing and analysis.

In some embodiments, method 200 proceeds to step 220, which involves inputting, by the one or more processors, the first data object to a first instance of a machine-learning model. The machine-learning model is configured to identify one or more intents associated with the first data object. This step is configured to assist in understanding the user's purpose or goal behind their interaction with the order management system. By inputting the first data object to the machine-learning model, the system can extract insights into the user's intentions, enabling it to provide more accurate and relevant responses.

In some embodiments, the machine-learning model used in step 220 may be a pre-trained model that has undergone foundational training on a large corpus of text data. This foundational training allows the model to develop a general understanding of language and its nuances. However, to tailor the model specifically for the task of intent identification in the context of order management, the model may undergo additional fine-tuning. This fine-tuning process involves training the model on a more focused dataset that is relevant to the domain of order management, such as intent identification (e.g., using tagged data). By exposing the model to specific examples of user interactions and their corresponding intents, the model learns to recognize patterns and features that are indicative of different intents within the order management context.

In some embodiments, the machine-learning model may be further modified, fine-tuned, or configured using prompting techniques. Prompting involves providing the model with additional context or instructions that guide its behavior and output. In the case of intent identification, prompts can be used to prime the model to focus on specific aspects of the user interaction or to consider certain criteria when determining the intent. For example, a prompt may instruct the model to more significantly weight keywords or phrases that are commonly associated with different intents, such as “add to cart,” “remove item,” or “check order status,” Relative to other keywords or phrases. By incorporating these prompts into the input data, the model's context window is utilized for training or modifying the model with each input, making the model state configured and/or unique to the present data object and the overall context and/or state of the system.

In some embodiments, the machine-learning model used in step 220 is configured to handle a wide range of intents that are relevant to the order management domain. These intents may include, but are not limited to, adding items to the cart, removing items from the cart, modifying item quantities, applying discounts or coupons, checking order status, requesting shipping information, or providing feedback. The model is trained to recognize the nuances and variations in how users express these intents, taking into account factors such as language, language style, tone, and context. By leveraging the power of machine-learning and natural language processing techniques, the model can accurately map the user's input to the corresponding intent, even in cases where the user's expression may be ambiguous or incomplete.

In some embodiments, the first instance of the machine-learning model used in step 220 is part of a larger ensemble of models that work together to identify intents. Each model in the ensemble may specialize in detecting specific types of intents or may be trained on different subsets of the data. The outputs from these models are then combined using techniques such as averaging, weighting, weighted averaging, or the like to arrive at the final intent prediction. This ensemble approach can help improve the robustness and accuracy of the intent identification process, as it leverages the strengths of multiple models and mitigates the weaknesses of individual models. The ensemble may also include models that are trained on different types of data, such as text, voice, or images, allowing the system to handle a broader range of user interactions and intents.

In some embodiments, method 200 proceeds to step 230, which involves receiving, by the one or more processors, an identified intent from the first instance of the machine-learning model. The identified intent represents the model's interpretation of the user's goal or purpose based on the input provided in the first data object. This intent is typically represented as a categorical label or a probability distribution over a set of predefined intent categories. The one or more processors are configured to receive this identified intent as an output from the machine-learning model and store it in memory for further processing in subsequent steps of the method. It will be understood that an intent received at step 230 may be a single intent, a combination of a plurality of intents, and/or a combined intent based on a plurality of intents.

In some embodiments, method 200 proceeds to step 240, which involves generating, by the one or more processors based on the identified intent, a second data object. The second data object is configured to include the one or more intents identified in the previous step, along with a first prompt and a first function selected based on those intents. This step 240 may include transforming the identified intent into a format that can be effectively processed by a second instance of the machine-learning model.

In some embodiments, the second data object serves as an input prompt to the second instance of the machine-learning model. The one or more processors are configured to generate this input prompt based on the identified intent, such that the prompt is tailored to the specific goal, purpose, and/or intent expressed by the user. The identified intent may be directly incorporated into the prompt, providing the necessary context for the model to generate an appropriate response. For example, if the identified intent is “add item to cart,” the prompt may be constructed as “User wants to add an item to their shopping cart. Identify the specific item and quantity based on the following information: [first data object].” It will be appreciated that other similar prompting techniques may be utilized.

In some embodiments, the first prompt included in the second data object may be generated dynamically based on the identified intent and other relevant parameters from the first data object. The one or more processors are configured to analyze the intent and select the most appropriate prompt template from a predefined set of templates. These templates are configured to cover a wide range of intents and scenarios, and they include placeholders for specific information to be extracted from the first data object. For example, a template for the “modify item quantity” intent may be “User wants to change the quantity of an item in their cart. Identify the item and the new quantity based on the following information: [first data object].” The one or more processors then populate the placeholders with the relevant information from the first data object, such as the item name or the desired quantity, to create a complete and context-specific prompt.

In some embodiments, the second data object also includes a first function selected based on the one or more intents. The first function represents the specific action or operation that needs to be performed to fulfill the user's intent. The one or more processors are configured to select the appropriate function from a predefined set of functions based on the identified intent. For example, if the intent is “remove item from cart,” the corresponding function may be “remove item from cart.” This function encapsulates the necessary logic and steps required to remove the specified item from the user's shopping cart. By including the first function in the second data object, the one or more processors ensure that the appropriate action is triggered based on the user's intent, streamlining the order management process.

In some embodiments, the second data object generated in step 240 serves as a comprehensive input to the second instance of the machine-learning model. It encapsulates the identified intent, the context-specific prompt, and the selected function, providing the model with all the necessary information to generate an accurate and relevant response. The one or more processors are configured to serialize the second data object into a format that is compatible with the input requirements of the machine-learning model, such as JSON or XML. This serialized data object is then passed to the model for further processing in the subsequent steps of the method.

In some embodiments, the second instance of the machine-learning model used in the subsequent steps of method 200 may be a model that is further trained or modified specifically for the identified intent and/or the selected function. While the first instance of the model is configured to identify general intents, the second instance is configured to specialize in handling specific intents and performing the associated functions. For example, if the identified intent is “add item to cart,” the second instance of the model may be trained on a dataset that focuses specifically on extracting item details, quantities, and other relevant information from user inputs related to adding items to a shopping cart. This specialized training allows the model to develop a deeper understanding of the specific language patterns, keywords, and context associated with the “add item to cart” intent, enabling it to generate more accurate and relevant responses. Similarly, if the selected function is “remove item from cart” the second instance of the model may be fine-tuned to handle user inputs related to removing items from a cart, such as identifying the specific item to be removed and the quantity to be deducted. By tailoring the model to the specific intent and function, the one or more processors may improve the overall performance and accuracy of the order management system.

In some embodiments, the method includes selecting a second instance of the machine-learning model based on the first data object. The selection is configured to leverage the information contained in the first data object, such as user input, query type, or metadata, to identify the most appropriate model instance for further processing. This instance is configured to identify and process intents and item classifications within this context. Additionally, the system is configured to access and analyze historical data from a database to refine its selection, ensuring that the chosen model instance aligns with the specific characteristics and needs reflected in the first data object.

In some embodiments, method 200 proceeds to step 260, which involves receiving, by the one or more processors from the second instance of the machine-learning model, an item classification data object. This step is configured to capture the output generated by the machine-learning model in the previous step and convert it into a structured format that can be processed and utilized by the order management system. The one or more processors are configured to receive the item classification data object and store it in memory or in a database 125 for further analysis and action.

The item classification data object received in step 260 is a structured representation of the item classifications generated by the second instance of the machine-learning model. It is configured to encapsulate various pieces of information that are relevant to identifying and processing the specific items or products mentioned in the user's input. The item classification data object may include fields such as the predicted item name, brand, category, size, color, quantity, and other relevant attributes extracted by the model. For example, if the user's intent is to add a specific item to their cart, the item classification data object may contain fields like “item name: red cotton t-shirt,”“brand: ABC Apparel,” “category: clothing,” “size: large,” “color: red,” and “quantity: 1.” This structured data is configured to allow the order management system to extract and use the relevant information for subsequent processing steps, such as updating the user's cart, checking inventory availability, or generating order confirmations. The item classification data object may also include metadata such as confidence scores or probability values associated with each predicted attribute, indicating the model's level of certainty in its classifications. Additionally, the data object may incorporate information from the original user input, such as the exact text or voice transcript, to provide context and allow for further refinement or validation of the item classifications.

In some embodiments, the fields within the item classification data object are identified based on the classification data generated by the second instance of the machine-learning model. The model is configured to select relevant fields from a larger set of potential attributes, dynamically determining which fields are pertinent based on the specific context and content of the user's input. This selection process ensures that only the most relevant attributes are included, streamlining the data object and focusing on the key details necessary for accurate and efficient processing by the order management system.

In some embodiments, one or more instances of the machine-learning model can utilize its training and access to a database to fill in gaps in user requests. For instance, if a user prompts the system to “add a red shirt to the cart,” the machine-learning model can access a database of historical orders to determine the user's preferred size, type of red, collar style, and other relevant details. By analyzing past user orders or profile information, the system can automatically extract and apply these specifications, resulting in a more personalized and accurate response to the user's request.

In some embodiments, method 200 proceeds to step 270, which involves performing, by the one or more processors based on the item classification data object, one or more actions related to the first function. This step is configured to execute the specific actions or operations that are necessary to fulfill the user's intent, as determined by the previous steps of the method. The one or more processors are configured to retrieve the item classification data object and the first function from memory, and use this information to trigger the appropriate actions within the order management system.

The specific actions performed in step 270 are determined by the first function, which is selected based on the user's intent. For example, if the user's intent is to add an item to their shopping cart, the first function may be “add_to_cart.” In this case, the one or more processors are configured to extract the relevant item details from the item classification data object, such as the item name, quantity, and price, and use this information to update the user's shopping cart in the database. Similarly, if the user's intent is to remove an item from their cart, the first function may be “remove_from_cart,” and the one or more processors are configured to locate the specified item in the user's cart and remove it from the database.

The actions performed in step 270 are configured to be flexible and extensible, allowing the order management system to handle a wide range of user intents and functions. The specific actions performed are determined by the first function and the item classification data object, which are generated based on the user's input and the machine-learning models used in the previous steps of the method. By performing these actions, the order management system is able to provide a seamless and intuitive user experience, while also efficiently managing the various aspects of the order process.

In some embodiments, the method includes a third instance of the machine-learning model configured to perform one or more of the functions discussed herein or to execute one or more aspects of these functions. For example, the third instance may be responsible for relevance filtering, where it evaluates and prioritizes the information based on its relevance to the user's query. It may also handle volume detection, accurately determining the quantity of items specified by the user. Additionally, this instance could manage other LLM-based operations such as context understanding, item classification refinement, or generating user prompts for missing information. The designation of “first,” “second,” and “third” instances within this disclosure is for illustrative purposes and is not intended to limit the system to these specific instances. These terms are interchangeable, and the disclosure contemplates the use of additional instances as needed to enhance the functionality and performance of the system. Each instance can be configured and deployed to handle specific tasks or a combination of tasks, thereby providing a flexible and scalable approach to order management and user interaction.

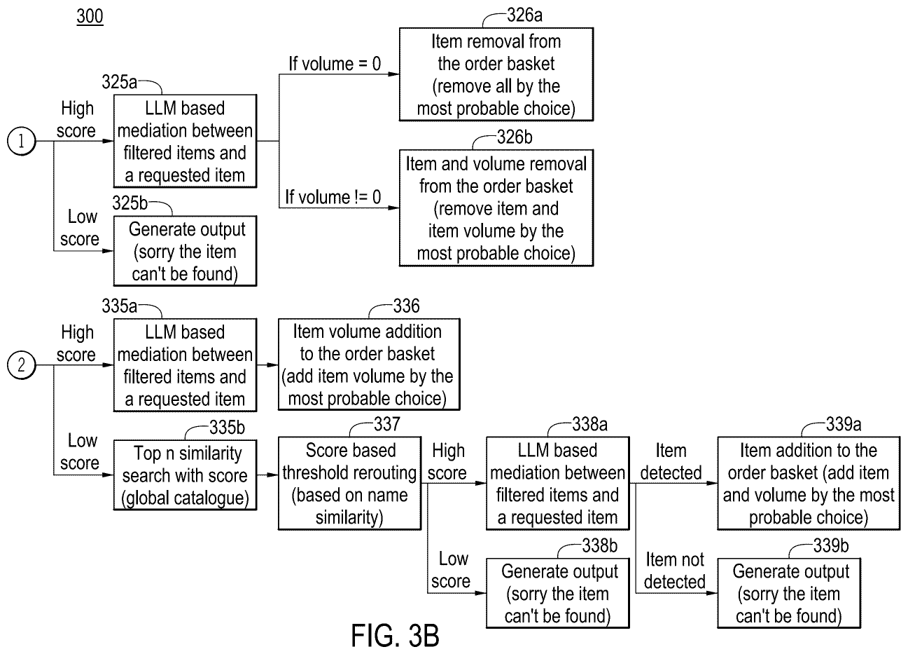

FIG. 3 illustrates a flowchart 300 depicting a detailed view of the actions performed in step 270 of method 200, according to some embodiments. The flowchart begins with a conversation entry point 301, which represents the initial user input or interaction that triggers the order management process. This input is passed to step 302, where a multi-shot intent detection is performed using a large language model (LLM). The LLM is configured to analyze the user's input and determine their intent, which could be a search query, a request to perform an action such as add or remove items from the cart, a purchase confirmation, etc.

In some embodiments, the search function 310 is initiated when the user's intent is determined to be a search query. The function begins by receiving the multi-shot LLM-based item classification 311, which is the output generated by the item classification step 260 in method 200. This item classification data object is configured to contain information about the user's search query, such as the product name, brand, category, attributes, or other relevant details that help narrow down the search scope.

Once the item classification is received, the search function 310 proceeds to perform a top-n similarity search with a score across a catalog 312. This catalog is typically a global product catalog that contains information about all the items available for purchase, but may in some embodiments be a sub-set of the global catalog. The similarity search is configured to compare the user's search query with the product information in the catalog and assign a relevance score to each potential match. The search algorithm may utilize various techniques, such as keyword matching, semantic analysis, or machine-learning, to determine the similarity between the query and the catalog items.

After the similarity search is completed, the search function 310 filters the results based on the resulting similarity scores 313. This filtering step is configured to narrow down the search results to the most relevant items. The filtering process may involve comparing the similarity scores to a predefined threshold value, which determines the minimum level of relevance required for an item to be included in the search results. In some cases, the threshold value may be dynamic and adjust based on the number or quality of the search results. For example, if the search yields a large number of highly relevant items, the threshold may be raised to only include a specific percentage or total number of the top-performing results.

The filtered search results, represented as a filtered data object, are then input to an instance of the LLM for relevance-based filtering 314. This additional filtering step is configured to further refine the search results by considering the context and semantics of the user's query. The LLM is configured to analyze the filtered data object and the user's original search query to determine the most relevant items based on factors such as synonyms, related terms, or contextual information. The LLM may also consider the user's preferences, purchase history, or other personalized data to provide more tailored recommendations.

In some embodiments, the search function 310 receives the refined search results from the LLM and prepares them for display to the user. The resulting items are typically presented within a text window or other user interface element, along with relevant information such as the product name, description, price, and image. In some cases, the search results may be accompanied by prompts or examples to guide the user's selection or provide additional context. For instance, if the user searched for a specific type of product, the search results may include a prompt suggesting related accessories or compatible items. Once the search results are displayed, the user can interact with them by selecting an item to view more details, adding it to their cart, or refining their search query.

In some embodiments, the remove function 320 is initiated when the user's intent is determined to be a request to remove an item from their shopping cart. The function begins by receiving the multi-shot LLM-based item classification 321, which is similar to the item classification received in the search function 310. This item classification data object is configured to contain information about the item the user wishes to remove, such as the product name, brand, or other identifying details.

Upon receiving the item classification, the remove function 320 performs a top-n similarity search with a score across the user's shopping cart 322. This similarity search is configured to locate the item within the user's cart that most closely matches the item classification. The search algorithm compares the item classification with the details of each item in the cart and assigns a similarity score based on the level of match. This step helps ensure that the correct item is identified for removal, even if the user's description is not an exact match.

After the similarity search, the remove function 320 applies the data object to an instance of the LLM to identify the volume or quantity associated with the user's request 323. This step is relevant to embodiments where the user may wish to remove a specific number of items rather than the entire quantity. The LLM analyzes the user's input to extract any mention of quantity, such as “remove 2 shirts” or “take out 1 [item].” If no specific quantity is mentioned, in some embodiments the LLM is configured to default to removing a specific quantity, such as one or the entire quantity of the matched item.

The remove function 320 then performs a score-based threshold rerouting 324 based on the similarity search score. Referring now to FIG. 3B, if the score is low, indicating that no close match was found in the user's cart, the function generates an output 325b informing the user that the item could not be found. This output may also include suggestions for similar items that the user might have meant to remove. On the other hand, if the similarity score is high, the function proceeds to perform an LLM-based mediation between the filtered items and the requested item 325a. This mediation step is configured to resolve any ambiguity or uncertainty in the user's request by considering the context and semantics of their input.

When the mediation step confirms that the user intends to remove the entire quantity of the matched item, the remove function 320 proceeds to remove the item from the order basket 326a. This step involves updating the user's cart to remove the item and any associated details, such as the price. If the mediation step determines that the user only wishes to remove a specific quantity, the function performs an item and volume removal from the order basket 326b. This step involves updating the cart to reflect the new quantity of the item, while keeping the item itself in the cart. Once the removal process is complete, the updated cart information is saved, and the user is informed of the successful removal of the item or quantity.

Referring again to FIG. 3A, in some embodiments, the add function 330 is initiated when the user's intent is determined to be a request to add an item to their shopping cart. The function begins by receiving the multi-shot LLM-based item classification 331, which is similar to the item classification received in the search function 310 and remove function 320. This item classification data object is configured to contain information about the item the user wishes to add, such as the product name, brand, or other identifying details.

The add function 330 starts by performing a top-n similarity search with a score across the user's shopping cart 332, similar to the search performed in the remove function 320. This similarity search is configured to determine if the requested item is already present in the user's cart, and utilizes a score based threshold rerouting based on name similarity 334, similar to 324. Referring to FIG. 3B, if a high similarity score is found, it indicates that the item is already in the cart, and the function proceeds to step 335a for LLM-based mediation and quantity update.

If the similarity search yields a low score, suggesting that the item is not currently in the cart, the add function 330 applies the data object to an instance of the LLM to identify the volume or quantity associated with the user's request 333. This step is similar to the quantity identification 323 in the remove function 320, where the LLM analyzes the user's input to extract any mention of the desired quantity to add.

In the case where the item is not found in the user's cart, the add function 330 performs a top-n similarity search with a score against a global product catalog 335b. This search is configured to locate the item within the catalog that best matches the user's request. The search algorithm compares the item classification with the details of each product in the catalog and assigns a similarity score based on the level of match. The add function 330 them performs an item volume addition to the order basket 336 by adding the item and volume of the most probable choice.

After the catalog search, the add function 330 performs a score-based threshold rerouting based on the name similarity 337. If the similarity score is low, indicating that no close match was found in the catalog, the function generates an output 338b informing the user that the item could not be found. This output may also include suggestions for similar items or prompt the user to provide more specific information. If the similarity score is high, the function proceeds to perform an LLM-based mediation between the filtered items and the requested item 338a. This mediation step is configured to resolve any ambiguity or uncertainty in the user's request by considering the context and semantics of their input. If the mediation step confirms that the user intends to add the matched item to their cart, the function performs an addition to the shopping cart of the most probable item and the specified quantity 339a. This step involves updating the user's cart to include the new item, along with its price, shipping information, and any other relevant details. If the mediation step is unable to confidently match the user's request to a specific item, the function generates an output saying the item cannot be found 339b, similar to the output in step 338b. Once the addition is complete or the user is informed of the inability to find the item, the updated cart information is saved, and the add function 330 concludes.

In some embodiments, it will be appreciated that the order management platform 120 may include a variety of other functions that operate in a similar manner to the search function 310, remove function 320, and add function 330. These additional functions are configured to handle specific user intents and requests related to the ordering process. For example, a “modify quantity” function may allow users to change the quantity of an item already in their cart, following similar steps to the remove and add functions to identify the item and update its quantity. A “save for later” function may enable users to move items from their active cart to a saved list for future consideration, utilizing similarity searches and LLM-based mediation to identify the appropriate items. Other possible functions include “apply coupon,” “check order status,” “provide feedback,” “request return or exchange,” and “ask for recommendations.” Each of these functions would leverage the multi-shot LLM-based item classification, similarity searches, and LLM-mediated decision-making to interpret user intents, locate relevant items or orders, and perform the desired actions.

In some embodiments, when the intent classification step 302 is unable to identify the user's intent with sufficient confidence, or the user explicitly indicates a need for help or assistance, the system routes the interaction to the FAQ function 340. The FAQ function is configured to provide users with general information, guidance, and support related to the order management process. When activated, the FAQ function 340 prompts the user to provide a question or topic of interest. This user input is then passed to the LLM-based FAQ response component 341, which is responsible for generating an appropriate response. The LLM-based FAQ response component 341 utilizes a retrieval-augmented generation (RAG) approach, which combines information retrieval techniques with language model generation. The RAG database 342 is a curated collection of frequently asked questions, product information, order management policies, and other relevant content. When generating a response, the LLM-based FAQ response component 341 searches the RAG database 342 for the most relevant information based on the user's question. It then uses this retrieved information to generate a natural language response that addresses the user's query. The generated response is returned to the user through the conversation interface, providing them with the requested assistance or information. If the user's question cannot be satisfactorily answered by the FAQ function 340, the system may escalate the interaction to a human customer support representative for further assistance.

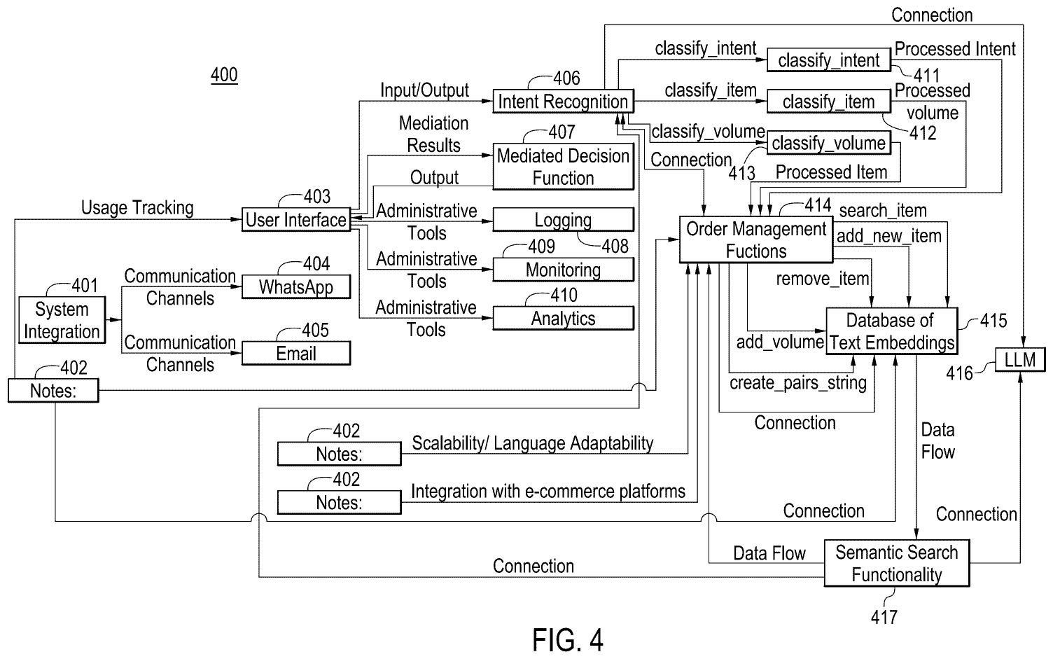

Referring to FIG. 4, in some embodiments, diagram 400 illustrates the comprehensive structure and interactions within an order management system leveraging machine-learning models. The system integration module 401 interfaces with various communication channels, such as WhatsApp™ 404 and Email 405, configured to facilitate user interactions and data collection. The user interface 403 serves as the primary interaction point, allowing users to input data and receive responses from the system. This interface is configured to process input/output operations and mediation results from the mediated decision function 407, which in turn utilizes intent recognition 406 to classify and interpret user intents via classify_intent 411, classify_item 412, and classify_volume 413 modules.

In some embodiments, the mediated decision function 407 processes user intents and mediates decisions based on data received from logging 408, monitoring 409, and analytics 410 components. These components ensure a comprehensive understanding of user interactions and system performance. The order management functions 414 utilize data from the database of text embeddings 415 and leverage large language models 416 to execute tasks. The semantic search functionality 417 further enhances the system's ability to understand and process complex queries. This system configuration facilitates efficient management and processing of user interactions, ensuring accurate and relevant responses are generated and integrated within the e-commerce platforms.

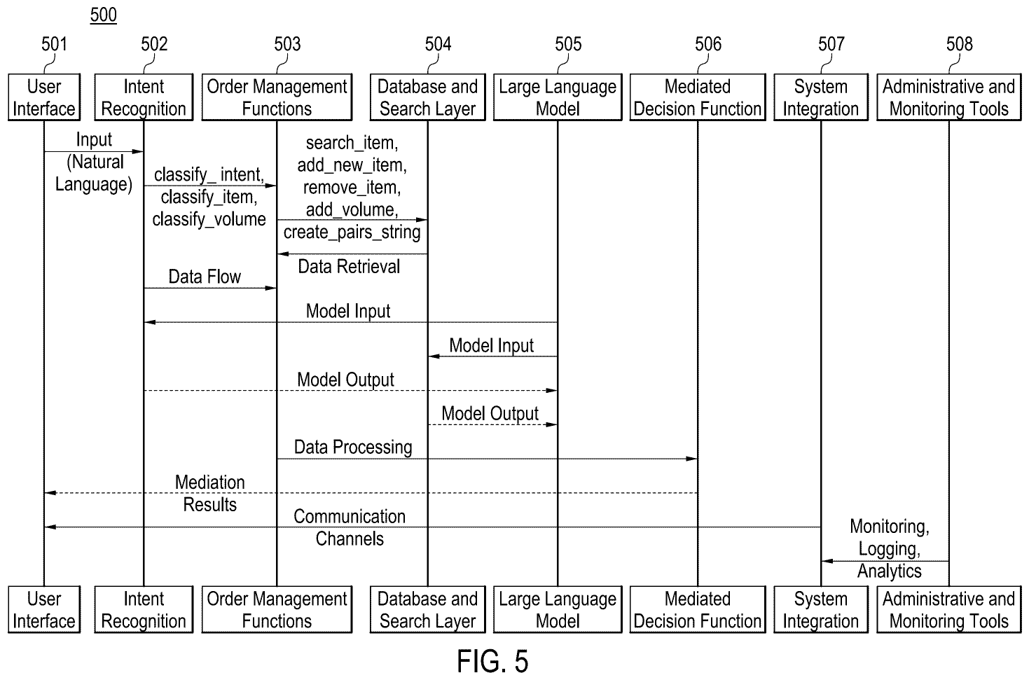

Referring to FIG. 5, in some embodiments, diagram 500 illustrates the data flow and interactions between various components within an order management system utilizing advanced machine-learning techniques. The process begins with the user interface 501, which is configured as the entry point for natural language inputs from users. These inputs are directed to the intent recognition module 502, configured to classify user intents, items, and volumes through processes such as classify_intent, classify_item, and classify_volume. This initial classification step is configured such that the user's input is understood and categorized for further processing.

In some embodiments, the classified data is then passed to the order management functions 503. This module handles various operations, including searching for items, adding new items, removing items, adjusting volumes, and creating pairs of data strings. The data retrieval step ensures that relevant information is fetched from the database and search layer 504, which stores and indexes the necessary data for efficient access. The large language model 505 processes the model input to generate relevant model output, which is then utilized by the order management functions 503. The mediated decision function 506 refines these outputs for further data processing and actionable mediation results. The system integration 507 is configured to facilitate communication across various channels, ensuring that the system components interact cohesively. The administrative and monitoring tools 508 are configured to oversee the monitoring, logging, and analytics, maintaining optimal system performance and enabling continuous improvements based on real-time data insights. This structured interaction and data flow facilitate efficient order management and enhanced user experience.

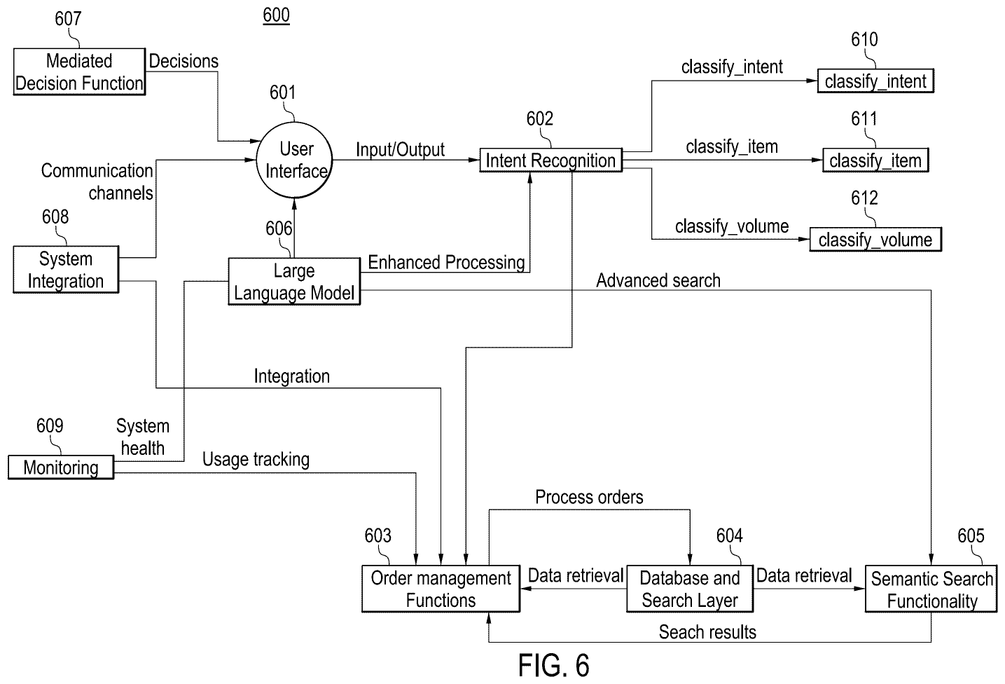

Referring to FIG. 6, in some embodiments, diagram 600 illustrates the data flow and interactions between various components within an order management system employing machine-learning and advanced search techniques. The process begins at the user interface 601, where users input their natural language queries. These inputs are then forwarded to the intent recognition module 602, which processes the inputs through classify_intent 610, classify_item 611, and classify_volume 612 to understand and categorize the user's requests accurately.

In some embodiments, the classified data from the intent recognition module 602 is sent to the order management functions 603. Order management functions 603 are configured to handle operations such as processing orders based on the classified data. Order management functions 603 then send these orders to the database and search layer 604 for storage and indexing, ensuring efficient data retrieval when desired. The database and search layer 604 retrieves the relevant data and sends it back to the order management functions 603 for further processing.

In some embodiments, the semantic search functionality 605 receives data retrieval requests from the database and search layer 604. Semantic search functionality 605 is configured to perform advanced searches to retrieve relevant data based on user queries and sends the search results back to the order management functions 603. This enables the system to provide accurate and relevant search results to user queries. In some embodiments, the large language model 606 enhances the processing capabilities of the intent recognition module 602 by refining and/or further processing the input data. Additionally, the large language model 606 provides advanced search capabilities to the semantic search functionality 605, improving the system's ability to retrieve and present relevant information.

In some embodiments, the mediated decision function 607 provides decisions to the user interface 601, such that users receive precise and actionable responses. In some embodiments, the system integration 608 is configured for communication and interaction among the system components. System integration 608 is configured to provide communication channels to the user interface 601 and integrates data into the order management functions 603, maintaining cohesive system operations.

In some embodiments, monitoring 609 is configured to oversee the overall system performance by tracking system health and providing this information to the user interface 601. Monitoring 609 is also configured to provide usage tracking data to the order management functions 603 to support efficient operation. Monitoring 609 is configured to support maintaining system efficiency and providing feedback for continuous improvement, supporting optimal performance and user satisfaction. This structured interaction and data flow enable the system to manage user interactions efficiently and deliver accurate and relevant responses to user queries.

In some embodiments, an initial prompt may be provided to the user, which may be generated by one or more language models or other system processes. This initial prompt may consist of a suggested proposal of items to add to the user's shopping cart, including specified volumes. The generation of this prompt is based on various factors, including the user's shopping history, preferences, and behaviors. Additionally, the prompt generation may utilize a model trained on data from users with similar profiles, preferences, or shopping habits. This model may be refined using a subset of users, a broader user base, or any other relevant training data that enhances the accuracy and relevance of the suggested items.

In some embodiments, prompts for various functions within the system can be generated from predefined templates. These templates serve as standardized formats that can be customized with specific data inputs to generate appropriate prompts for different functions or steps of a function. The prompts generated from these templates are configured to be fed into an LLM for processing, such that the system can handle a wide range of user intents efficiently. Each function or step within a function may have its own distinct prompt template, allowing the system to tailor its responses based on the specific requirements of each interaction.

In some embodiments, the prompts may utilize data from one or more previous steps, such as the initial conversation input, additional user inputs, or data generated from earlier steps in the process. This is configured such that the prompts are contextually relevant and informed by the user's ongoing interaction with the system. For example, in the “add” function, the template may include placeholders for item names, quantities, and any relevant user preferences or constraints. An example template for the “add” function could be: “Please add [quantity] of [item] to my cart. Ensure that the total cost does not exceed [budget].” This template can be dynamically populated with data from the user's previous inputs or the system's recommendations.

In some embodiments, the “remove” function may have a template configured to prompt the LLM to understand which items need to be removed from the user's cart. An example template for the “remove” function could be: “Please remove [quantity] of [item] from my cart.” This template allows for flexibility in specifying the items and quantities to be removed, ensuring that the system can accurately process the user's request based on current cart contents and any additional context provided by the user.

In some embodiments, the “search” function may utilize a template that guides the LLM in conducting an efficient search based on the user's query. An example template for the “search” function could be: “Search for [item] within [category] and provide options that match [specific criteria].” This template can be customized with user-specific search criteria, previous search inputs, or system-generated suggestions to ensure that the search results are relevant and comprehensive.

In some embodiments, the prompts generated from templates may also include structured response templates to guide the LLM in structuring its responses to the query. These structured response templates utilize the context window to modify the LLM's behavior, ensuring it performs specific functions more accurately. By incorporating these templates within the prompts, the system configured the LLM to understand the desired format and context for each function, thereby improving the quality and relevance of the responses.

For instance, in the “add” function, a structured response template might be included within the prompt to illustrate the desired outcome. An example template for the “add” function with a structured response template could be: “Please add [quantity] of [item] to my cart. Ensure that the total cost does not exceed [budget]. For example: ‘Added [quantity] of [item] to your cart, with a total cost of [total_cost].” Similarly, in the “remove” function, the prompt may include a structured response template to clarify the expected action. An example template for the “remove” function with a structured response template might be: “Please remove [quantity] of [item] from my cart. For example: ‘Removed [quantity] of [item] from your cart. Your cart now contains [remaining_quantity] of [item].” Similarly, in the “search” function, the prompt can be enhanced with a structured response template to guide the LLM in providing effective search results. An example template for the “search” function with a structured response template could be: “Search for [item] within [category] and provide options that match [specific criteria]. For example: ‘Found the following options for [item] within [category]: 1. [Option 1 details] 2. [Option 2 details] . . . ”.

In some embodiments, the system is configured to leverage advanced machine-learning techniques to analyze historical data and predict the most relevant items for the user. The initial prompt may also incorporate seasonal trends, promotional items, and frequently purchased goods to optimize the user's shopping experience. By utilizing a combination of personalized user data and aggregated data from a larger user base, the system can provide tailored recommendations that align with the user's needs and preferences. This approach not only improves user satisfaction but also increases the efficiency of the shopping process, making it more intuitive and user-friendly.

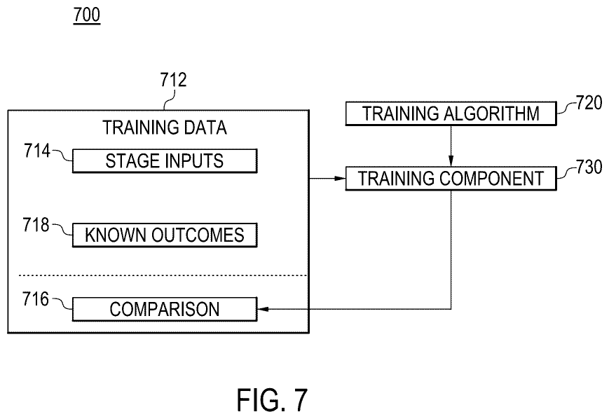

One or more implementations disclosed herein include and/or are implemented using a machine-learning model. For example, one or more of the modules of the order management platform 120 are implemented using a machine-learning model and/or are used to train the machine-learning model. FIG. 7 shows an example machine-learning training flow chart, according to some embodiments of the disclosure. Referring to FIG. 7, a given machine-learning model is trained using the training flow chart 700. The training data 712 includes one or more of stage inputs 714 and the known outcomes 718 related to the machine-learning model to be trained. The stage inputs 714 are from any applicable source including text, visual representations, data, values, comparisons, and stage outputs, e.g., one or more outputs from one or more components and/or steps from FIGS. 1-6. The known outcomes 718 are included for the machine-learning models generated based on supervised or semi-supervised training, or can based on known labels, such as topic labels. An unsupervised machine-learning model is not trained using the known outcomes 718. The known outcomes 718 includes known or desired outputs for future inputs similar to or in the same category as the stage inputs 714 that do not have corresponding known outputs.

The training data 712 and a training algorithm 720, e.g., one or more of the modules implemented using the machine-learning model and/or are used to train the machine-learning model, is provided to a training component 730 that applies the training data 712 to the training algorithm 720 to generate the machine-learning model. According to an implementation, the training component 730 is provided comparison results 716 that compare a previous output of the corresponding machine-learning model to apply the previous result to re-train the machine-learning model. The comparison results 716 are used by the training component 730 to update the corresponding machine-learning model. The training algorithm 720 utilizes machine-learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, classifiers such as K-Nearest Neighbors, and/or discriminative models such as Decision Forests and maximum margin methods, the model specifically discussed herein, or the like.

The machine-learning model used herein is trained and/or used by adjusting one or more weights and/or one or more layers of the machine-learning model. For example, during training, a given weight is adjusted (e.g., increased, decreased, removed) based on training data or input data. Similarly, a layer is updated, added, or removed based on training data/and or input data. The resulting outputs are adjusted based on the adjusted weights and/or layers.

In general, any process or operation discussed in this disclosure is understood to be computer-implementable, such as the process illustrated in FIG. 2 are performed by one or more processors of a computer system as described herein. A process or process step performed by one or more processors is also referred to as an operation. The one or more processors are configured to perform such processes by having access to instructions (e.g., software or computer-readable code) that, when executed by one or more processors, cause one or more processors to perform the processes. The instructions are stored in a memory of the computer system. A processor is a central processing unit (CPU), a graphics processing unit (GPU), or any suitable type of processing unit.

A computer system, such as a system or device implementing a process or operation in the examples above, includes one or more computing devices. One or more processors of a computer system are included in a single computing device or distributed among a plurality of computing devices. One or more processors of a computer system are connected to a data storage device. A memory of the computer system includes the respective memory of each computing device of the plurality of computing devices.

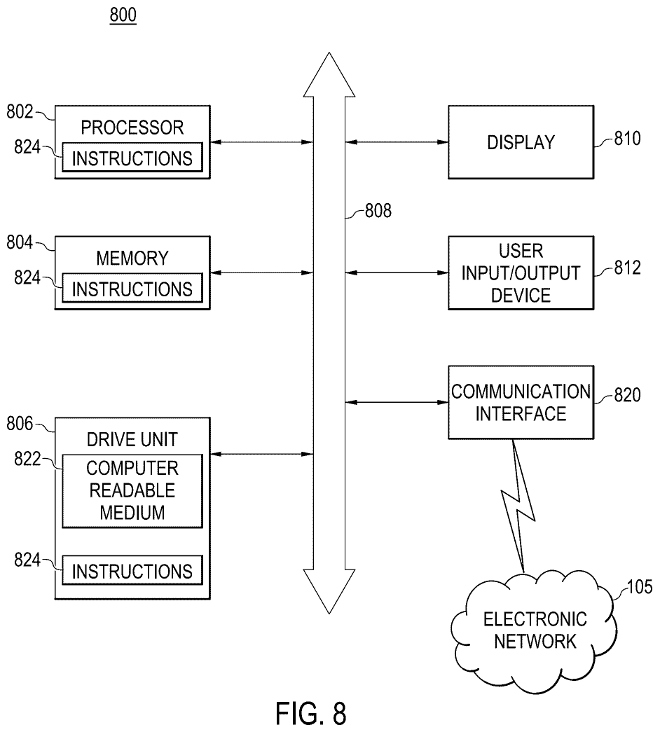

FIG. 8 illustrates an implementation of a computer system that executes techniques presented herein. The computer system 800 includes a set of instructions that are executed to cause the computer system 800 to perform any one or more of the methods or computer based functions disclosed herein. The computer system 500 operates as a standalone device or is connected, e.g., using a network, to other computer systems or peripheral devices.

Unless specifically stated otherwise, as apparent from the following discussions, it is appreciated that throughout the specification, discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” refers to any device or portion of a device that processes electronic data, e.g., from registers and/or memory to transform that electronic data into other electronic data that, e.g., is stored in registers and/or memory. A “computer,” a “computing machine,” a “computing platform,” a “computing device,” or a “server” includes one or more processors.

In a networked deployment, the computer system 800 operates in the capacity of a server or as a client user computer in a server-client user environment, or as a peer computer system in a peer-to-peer (or distributed) environment. The computer system 500 is also implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular implementation, the computer system 800 is implemented using electronic devices that provide voice, video, or data communication. Further, while the computer system 800 is illustrated as a single system, the term “system” shall also be taken to include any collection of systems or sub-systems that individually or jointly execute a set, or multiple sets, of instructions to perform one or more computer functions.

As illustrated in FIG. 8, the computer system 800 includes a processor 802, e.g., a central processing unit (CPU), a graphics processing unit (GPU), or both. The processor 802 is a component in a variety of systems. For example, the processor 802 is part of a standard personal computer or a workstation. The processor 802 is one or more processors, digital signal processors, application specific integrated circuits, field programmable gate arrays, servers, networks, digital circuits, analog circuits, combinations thereof, or other now known or later developed devices for analyzing and processing data. The processor 802 implements a software program, such as code generated manually (i.e., programmed).

The computer system 800 includes a memory 804 that communicates via bus 808. The memory 804 is a main memory, a static memory, or a dynamic memory. The memory 804 includes, but is not limited to computer-readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 804 includes a cache or random-access memory for the processor 802. In alternative implementations, the memory 804 is separate from the processor 802, such as a cache memory of a processor, the system memory, or other memory. The memory 804 is an external storage device or database for storing data. Examples include a hard drive, compact disc (“CD”), digital video disc (“DVD”), memory card, memory stick, floppy disc, universal serial bus (“USB”) memory device, or any other device operative to store data. The memory 804 is operable to store instructions executable by the processor 802. The functions, acts, or tasks illustrated in the figures or described herein are performed by the processor 802 executing the instructions stored in the memory 804. The functions, acts, or tasks are independent of the particular type of instruction set, storage media, processor, or processing strategy and are performed by software, hardware, integrated circuits, firmware, micro-code, and the like, operating alone or in combination. Likewise, processing strategies include multiprocessing, multitasking, parallel processing, and the like.

As shown, the computer system 800 further includes a display 810, such as a liquid crystal display (LCD), an organic light emitting diode (OLED), a flat panel display, a solid-state display, a cathode ray tube (CRT), a projector, a printer or other now known or later developed display device for outputting determined information. The display 810 acts as an interface for the user to see the functioning of the processor 802, or specifically as an interface with the software stored in the memory 804 or in the drive unit 806.

Additionally or alternatively, the computer system 800 includes an input/output device 812 configured to allow a user to interact with any of the components of the computer system 800. The input/output device 812 is a number pad, a keyboard, a cursor control device, such as a mouse, a joystick, touch screen display, remote control, or any other device operative to interact with the computer system 800.

The computer system 800 also includes the drive unit 806 implemented as a disk or optical drive. The drive unit 806 includes a computer-readable medium 822 in which one or more sets of instructions 824, e.g. software, is embedded. Further, the sets of instructions 824 embodies one or more of the methods or logic as described herein. The sets of instructions 824 resides completely or partially within the memory 804 and/or within the processor 802 during execution by the computer system 800. The memory 804 and the processor 802 also include computer-readable media as discussed above.

In some systems, computer-readable medium 822 includes the set of instructions 824 or receives and executes the set of instructions 824 responsive to a propagated signal so that a device connected to network 105 communicates voice, video, audio, images, or any other data over the network 105. Further, the sets of instructions 824 are transmitted or received over the network 105 via the communication port or interface 820, and/or using the bus 808. The communication port or interface 820 is a part of the processor 802 or is a separate component. The communication port or interface 820 is created in software or is a physical connection in hardware. The communication port or interface 820 is configured to connect with the network 105, external media, the display 810, or any other components in the computer system 800, or combinations thereof. The connection with the network 105 is a physical connection, such as a wired Ethernet connection, or is established wirelessly as discussed below. Likewise, the additional connections with other components of the computer system 800 are physical connections or are established wirelessly. The network 105 alternatively be directly connected to the bus 808.

While the computer-readable medium 822 is shown to be a single medium, the term “computer-readable medium” includes a single medium or multiple media, such as a centralized or distributed database, and/or associated caches and servers that store one or more sets of instructions. The term “computer-readable medium” also includes any medium that is capable of storing, encoding, or carrying a set of instructions for execution by a processor or that causes a computer system to perform any one or more of the methods or operations disclosed herein. The computer-readable medium 822 is non-transitory, and may be tangible.

The computer-readable medium 822 includes a solid-state memory such as a memory card or other package that houses one or more non-volatile read-only memories. The computer-readable medium 822 is a random-access memory or other volatile re-writable memory. Additionally or alternatively, the computer-readable medium 822 includes a magneto-optical or optical medium, such as a disk or tapes or other storage device to capture carrier wave signals such as a signal communicated over a transmission medium. A digital file attachment to an e-mail or other self-contained information archive or set of archives is considered a distribution medium that is a tangible storage medium. Accordingly, the disclosure is considered to include any one or more of a computer-readable medium or a distribution medium and other equivalents and successor media, in which data or instructions are stored.

In an alternative implementation, dedicated hardware implementations, such as application specific integrated circuits, programmable logic arrays, and other hardware devices, is constructed to implement one or more of the methods described herein. Applications that include the apparatus and systems of various implementations broadly include a variety of electronic and computer systems. One or more implementations described herein implement functions using two or more specific interconnected hardware modules or devices with related control and data signals that are communicated between and through the modules, or as portions of an application-specific integrated circuit. Accordingly, the present system encompasses software, firmware, and hardware implementations.

Computer system 800 is connected to the network 105. The network 105 defines one or more networks including wired or wireless networks. The wireless network is a cellular telephone network, an 802.10, 802.16, 802.20, or WiMAX network. Further, such networks include a public network, such as the Internet, a private network, such as an intranet, or combinations thereof, and utilizes a variety of networking protocols now available or later developed including, but not limited to TCP/IP based networking protocols. The network 105 includes wide area networks (WAN), such as the Internet, local area networks (LAN), campus area networks, metropolitan area networks, a direct connection such as through a Universal Serial Bus (USB) port, or any other networks that allows for data communication. The network 105 is configured to couple one computing device to another computing device to enable communication of data between the devices. The network 105 is generally enabled to employ any form of machine-readable media for communicating information from one device to another. The network 105 includes communication methods by which information travels between computing devices. The network 105 is divided into sub-networks. The sub-networks allow access to all of the other components connected thereto or the sub-networks restrict access between the components. The network 105 is regarded as a public or private network connection and includes, for example, a virtual private network or an encryption or other security mechanism employed over the public Internet, or the like.

In accordance with various implementations of the present disclosure, the methods described herein are implemented by software programs executable by a computer system. Further, in an example, non-limited implementation, implementations can include distributed processing, component/object distributed processing, and parallel processing. Alternatively, virtual computer system processing can be constructed to implement one or more of the methods or functionality as described herein.

Although the present specification describes components and functions that are implemented in particular implementations with reference to particular standards and protocols, the disclosure is not limited to such standards and protocols. For example, standards for Internet and other packet switched network transmission (e.g., TCP/IP, UDP/IP, HTML, and HTTP) represent examples of the state of the art. Such standards are periodically superseded by faster or more efficient equivalents having one or more of the same functions. Accordingly, replacement standards and protocols having the same or similar functions as those disclosed herein are considered equivalents thereof.

It will be understood that the steps of methods discussed are performed in one embodiment by an appropriate processor (or processors) of a processing (i.e., computer) system executing instructions (computer-readable code) stored in storage. It will also be understood that the disclosure is not limited to any particular implementation or programming technique and that the disclosure is implemented using any appropriate techniques for implementing the functionality described herein. The disclosure is not limited to any particular programming language or operating system.

It should be appreciated that in the above description of example embodiments of the disclosure, various features of the disclosure are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed disclosure requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this disclosure.

Furthermore, while some embodiments described herein include some but not other features included in other embodiments, combinations of features of different embodiments are meant to be within the scope of the disclosure, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the instructions for carrying out such a method or element of a method forms a means for carrying out the method or element of a method. Furthermore, an element described herein of an apparatus embodiment is an example of a means for carrying out the function performed by the element for the purpose of carrying out the disclosure.

In the description provided herein, numerous specific details are set forth. However, it is understood that embodiments of the disclosure are practiced without these specific details. In other instances, well-known methods, structures and techniques have not been shown in detail in order not to obscure an understanding of this description.

Thus, while there has been described what are believed to be the preferred embodiments of the disclosure, those skilled in the art will recognize that other and further modifications are made thereto without departing from the spirit of the disclosure, and it is intended to claim all such changes and modifications as falling within the scope of the disclosure. For example, any formulas given above are merely representative of procedures that may be used. Functionality may be added or deleted from the block diagrams and operations may be interchanged among functional blocks. Steps may be added or deleted to methods described within the scope of the present disclosure.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations and implementations are possible within the scope of the disclosure. Accordingly, the disclosure is not to be restricted except in light of the attached claims and their equivalents.

What is claimed is:

1. A computer-implemented method comprising;
receiving, by one or more processors, a first data object including text data related to one or more user interactions;
inputting, by the one or more processors, the first data object into a first instance of a machine-learning model, the machine-learning model configured to identify one or more intents associated with the first data object;
receiving, by the one or more processors, an identified intent from the first instance of the machine-learning model;
generating, by the one or more processors based on the identified intent, a second data object, the second data object including the one or more intents, a first prompt selected based on the one or more intents, and a first function selected based on the one or more intents;
inputting, by the one or more processors, the second data object into a second instance of the machine-learning model, the second instance of the machine-learning model configured to identify one or more item classifications;
receiving, by the one or more processors from the second instance of the machine-learning model, an item classification data object; and
performing, by the one or more processors based on the item classification data object, one or more actions related to the first function.

2. The method of claim 1, wherein the first function is a search function configured to identify one or more item classifications of the first data object.

3. The method of claim 2, wherein performing the one or more actions related to the search function comprises:
performing, by the one or more processors, a top-n similarity search with score across a catalogue based on the item classification data object;
filtering, by the one or more processors, results of the top-n similarity search based on a score threshold to generate a filtered data object;
inputting, by the one or more processors, the filtered data object into a third instance of the machine-learning model for relevance-based filtering; and
receiving, by the one or more processors from the third instance of the machine-learning model, one or more resulting catalogue items.

4. The method of claim 1, wherein the first function is an add function configured to add an item from a catalogue to a user account.

5. The method of claim 4, wherein performing the one or more actions related to the add function comprises:
performing, by the one or more processors, a top-n similarity search with score across a shopping cart associated with the user account based on the item classification data object;
inputting, by the one or more processors, the first data object into a third instance of the machine-learning model to identify a volume associated with the one or more user interactions;
receiving, by the one or more processors, a score from the top-n similarity search;
performing, by the one or more processors, a score-based threshold rerouting based on the score; and
adding, by the one or more processors, an identified item and volume to the shopping cart based on the score-based threshold rerouting.

6. The method of claim 1, wherein the first function is a remove function configured to remove an item from a user account.

7. The method of claim 6, wherein performing the one or more actions related to the remove function comprises:
performing, by the one or more processors, a top-n similarity search with score across a shopping cart associated with the user account based on the item classification data object;
inputting, by the one or more processors, the first data object into a third instance of the machine-learning model to identify a volume associated with the one or more user interactions;
receiving, by the one or more processors, a score from the top-n similarity search;
performing, by the one or more processors, a score-based threshold rerouting based on the score; and
removing, by the one or more processors, an identified item and volume from the shopping cart based on the score-based threshold rerouting.

8. The method of claim 1, wherein the first instance of the machine-learning model is a initial machine-learning model, and wherein the method further comprises fine-tuning the initial machine-learning model.

9. The method of claim 1, wherein the first instance of the machine-learning model is trained via prompt-engineering utilizing an existing context window of the machine-learning model to inject one or more of rules, guidelines, behaviors, output formats, or goals.

10. A system comprising memory and one or more processors communicatively coupled to the memory, the one or more processors configured to:
receive a first data object including text data related to one or more user interactions;
input the first data object into a first instance of a machine-learning model, the machine-learning model configured to identify one or more intents associated with the first data object;
receive an identified intent from the first instance of the machine-learning model;
generate, based on the identified intent, a second data object, the second data object including the one or more intents, a first prompt selected based on the one or more intents, and a first function selected based on the one or more intents;
input the second data object into a second instance of the machine-learning model, the second instance of the machine-learning model configured to identify one or more item classifications;
receive, from the second instance of the machine-learning model, an item classification data object; and
perform, based on the item classification data object, one or more actions related to the first function.

11. The system of claim 10, wherein the first function is a search function configured to identify one or more item classifications of the first data object.

12. The system of claim 11, wherein to perform the one or more actions related to the search function, the one or more processors are further configured to:
perform a top-n similarity search with score across a catalogue based on the item classification data object;
filter results of the top-n similarity search based on a score threshold to generate a filtered data object;
input the filtered data object into a third instance of the machine-learning model for relevance-based filtering; and
receive, from the third instance of the machine-learning model, one or more resulting catalogue items.

13. The system of claim 10, wherein the first function is an add function configured to add an item from a catalogue to a user account.

14. The system of claim 13, wherein to perform the one or more actions related to the add function, the one or more processors are further configured to:
perform a top-n similarity search with score across a shopping cart associated with the user account based on the item classification data object;
input the first data object into a third instance of the machine-learning model to identify a volume associated with the one or more user interactions;
receive a score from the top-n similarity search;
perform a score-based threshold rerouting based on the score; and
add an identified item and volume to the shopping cart based on the score-based threshold rerouting.

15. The system of claim 10, wherein the first function is a remove function configured to remove an item from a user account.

16. The system of claim 15, wherein to perform the one or more actions related to the remove function, the one or more processors are further configured to:
perform a top-n similarity search with score across a shopping cart associated with the user account based on the item classification data object;
input the first data object into a third instance of the machine-learning model to identify a volume associated with the one or more user interactions;
receive a score from the top-n similarity search;
perform a score-based threshold rerouting based on the score; and
remove an identified item and volume from the shopping cart based on the score-based threshold rerouting.

17. The system of claim 10, wherein the first instance of the machine-learning model is a stock machine-learning model, and wherein the one or more processors are further configured to fine-tune the stock machine-learning model.

18. The system of claim 10, wherein the first instance of the machine-learning model is trained via prompt-engineering utilizing an existing context window of the machine-learning model to inject one or more of rules, guidelines, behaviors, output formats, or goals.

19. One or more non-transitory computer-readable storage media including instructions that, when executed by one or more processors, cause the one or more processors to:
receive a first data object including text data related to one or more user interactions;
input the first data object into a first instance of a machine-learning model, the machine-learning model configured to identify one or more intents associated with the first data object;
receive an identified intent from the first instance of the machine-learning model;
generate, based on the identified intent, a second data object, the second data object including the one or more intents, a first prompt selected based on the one or more intents, and a first function selected based on the one or more intents;
input the second data object into a second instance of the machine-learning model, the second instance of the machine-learning model configured to identify one or more item classifications;
receive, from the second instance of the machine-learning model, an item classification data object; and
perform, based on the item classification data object, one or more actions related to the first function.

20. The one or more non-transitory computer-readable storage media of claim 19, wherein the first function is one of a search function configured to identify one or more item classifications of the first data object, an add function configured to add an item from a catalogue to a user account, or a remove function configured to remove an item from a user account.
